(19) United States
(12) Patent Application Publication
(10) Pub. No.: US 2018/0031102 A1
(43) Pub. Date: Feb. 1, 2018

(54) DIFFERENTIAL ASSEMBLY FOR MACHINE

(71) Applicant: Caterpillar Inc., Peoria, IL (US)

(72) Inventors: Amanda C. Doolittle, Peoria, IL (US); Omar J. Adragna, Peoria, IL (US)

(73) Assignee: Caterpillar Inc., Peoria, IL (US)

(21) Appl. No.: 15/221,740

(22) Filed: Jul. 28, 2016

(51) Int. Cl. F16H 48/24; F16H 48/08

(52) U.S. Cl. CPC F16H 48/24; F16H 48/08

(57) ABSTRACT

A differential assembly for a drive train having a first axle shaft and a second axle shaft is provided. The differential assembly includes a differential gear set, a first pinion gear disposed on the first axle shaft, a second pinion gear disposed on the second axle shaft, each of the first pinion gear and the second pinion gear being in meshing engagement with the differential gear set, and a differential locking arrangement mounted on at least one of the first axle shaft and the second axle shaft. The differential locking arrangement is adapted to selectively lock the first axle shaft with the second axle shaft.

### TECHNICAL FIELD

The present disclosure relates to differential assemblies, and more particularly relates to a lockable differential assembly for a machine.

### BACKGROUND

Typically, a differential assembly may be used in machines for driving wheels of the machine while also permitting a difference in rotational speed between the wheels. The differential assembly utilizes a gear system that permits two output shafts to rotate at different speeds. When the machine is operating on a surface where there is limited traction for different wheels, e.g., on a slippery road surface, one wheel may lose traction while the other wheel loses input torque. In order to avoid such a situation, differential action of the differential assembly needs to be locked.

Often, the differential assemblies are provided with a locking feature, referred to as a differential lock mechanism, to lock the differential action as and when required. The differential lock mechanism in a locked state thereof, allows both the output shafts to rotate at the same speed by transferring all available torque to both the output shafts. One example of differential locking mechanism includes a set of friction discs associated with a differential housing and the axle shafts. A piston applies force to engage the set of friction discs together. Therefore, when the differential is locked, power is transmitted through locked differential housing, gearing, and output shafts rather than through the differential gearing. However, there is no direct engagement of the output shaft even when the differential assembly is locked. Further, the size and configuration of the differential assembly may be critical when the differential assembly needs to fit within tight space constraints offered by the machine.

For reference, U.S. Pat. No. 4,344,335 relates to a power distributing device for four-wheel-drive vehicle including an input shaft, a first output shaft for transmitting power to rear wheels, a second output shaft for transmitting power to front wheels, a plane planetary gear set, a power train changing means and a synchronizing means. The plane planetary gear set includes a sun gear having a hollow shaft, a ring gear connected with the first output shaft, a planet carrier drivably connected with the input shaft, and planet gears carried by the planet carrier and engaged with the sun gear and the ring gear. The power train changing means includes a sliding sleeve and a sliding tube slidably mounted on the hollow shaft, engaged movably with the hollow shaft only in its axial direction, the sliding sleeve being selectively movable to engage either with a stationary portion of the device in a rear-wheel-drive condition or with the sun gear in a direct four-wheel-drive condition and a power distributing four-wheel-drive condition, the sliding tube being selectively movable to engage with the planet carrier in the direct four-wheel-drive condition. The synchronizing means is provided to inhibit nonsynchronous engagement of the sun gear with the stationary portion or the second output shaft.

### SUMMARY OF THE DISCLOSURE

In one aspect of the present disclosure, a differential assembly for a drive train having a first axle shaft and a second axle shaft is provided. The differential assembly includes a differential gear set, a first pinion gear disposed on the first axle shaft, a second pinion gear disposed on the second axle shaft, each of the first pinion gear and the second pinion gear being in meshing engagement with the differential gear set, and a differential locking arrangement mounted on at least one of the first axle shaft and the second axle shaft. The differential locking arrangement is adapted to selectively lock the first axle shaft with the second axle shaft.

In another aspect of the present disclosure, a drive train for transmitting driving power from a power source to a first axle shaft and a second axle shaft is provided. The drive train includes an input shaft configured to receive the driving power from the power source, a drive gear drivably coupled to the input shaft, and a differential assembly for transmitting the driving power from the drive gear to the first axle shaft and the second axle shaft. The differential assembly includes a differential gear set connected to the drive gear, a first pinion gear disposed on the first axle shaft, a second pinion gear disposed on the second axle shaft, each of the first pinion gear and the second pinion gear being in meshing engagement with the differential gear set, and a differential locking arrangement mounted on at least one of the first axle shaft and the second axle shaft. The differential locking arrangement is adapted to selectively lock the first axle shaft with the second axle shaft.

In yet another aspect of the present disclosure, a method of transmitting driving power by a differential assembly, is provided. The method includes providing a connection between a first axle shaft and a first pinion gear via a first locking member of the differential assembly, providing a connection between a second axle shaft and a second pinion gear, wherein a second locking member of the differential assembly is connected to the second pinion gear. The method further includes engaging a first friction surface of the first locking member with a second friction surface of the second locking member for synchronizing rotational speeds of the first axle shaft and the second axle shaft. The method further includes engaging the first locking member with the second locking member by moving the first locking member with respect to the second locking member, and locking the first axle shaft with the second axle shaft.

Other features and aspects of this disclosure will be apparent from the following description and the accompanying drawings.

### BRIEF DESCRIPTION OF THE DRAWINGS

FIG. 1 is a schematic view of a drive train of a vehicle;

FIG. 2 is a side sectional view of a differential assembly of the drive train, in accordance with an embodiment of the present disclosure;

FIG. 3 is a perspective exploded view of the differential assembly of the drive train, in accordance with an embodiment of the present disclosure;

FIG. 4 is a side sectional view of a differential assembly of the drive train, in accordance with another embodiment of the present disclosure

FIG. 5 is a perspective sectional view of the differential assembly of the drive train in a first position, in accordance with an embodiment of the present disclosure;

FIG. 6 is a perspective sectional view of the differential assembly of the drive train in a second position, in accordance with an embodiment of the present disclosure;

FIG. 7 is a perspective sectional view of the differential assembly of the drive train in a third position, in accordance with an embodiment of the present disclosure; and

FIG. 8 is flowchart of a method of transmitting driving power from a differential assembly, in accordance with an embodiment of the present disclosure.

### DETAILED DESCRIPTION

Wherever possible, the same reference numbers will be used throughout the drawings to refer to the same or the like parts. Moreover, references to various elements described herein are made collectively or individually when there may be more than one element of the same type. However, such references are merely exemplary in nature. It may be noted that any reference to elements in the singular is also to be construed to relate to the plural and vice-versa without limiting the scope of the disclosure to the exact number or type of such elements unless set forth explicitly in the appended claims.

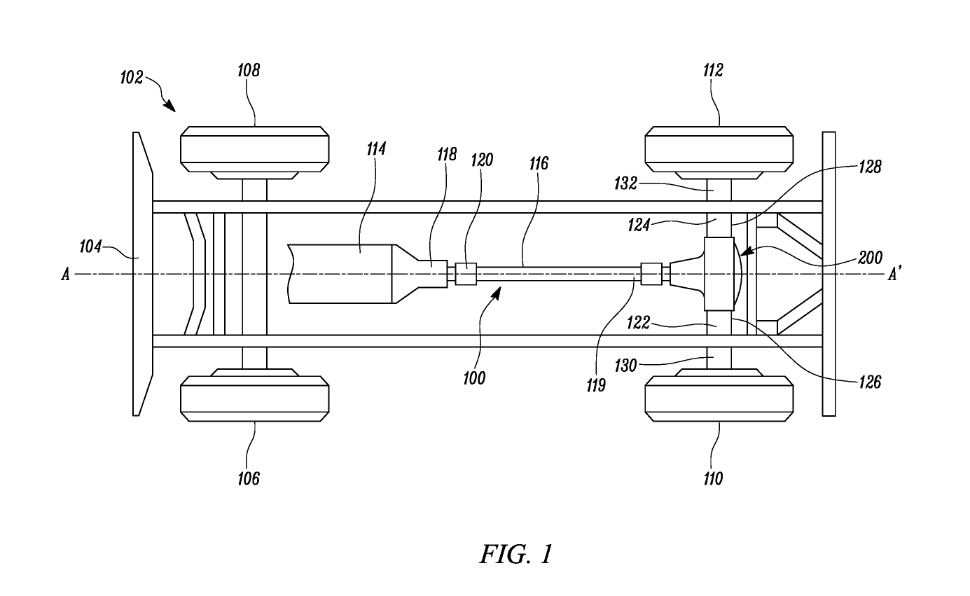

Referring to FIG. 1, a schematic view of a drive train 100 of an exemplary machine 102 is illustrated. The machine 102 may be embodied in the form of a backhoe loader, an excavator, a dozer, a wheel loader, a motor grader, an off-highway vehicle, an on-highway vehicle or other machines typically employed in applications, such as mining, forestry, waste management, construction, agriculture, transportation and the like. The present disclosure is generally relevant to any machine having the drive train 100, as will become evident from the following description.

The machine 102 includes a frame 104 and a set of ground engaging members rotatably supported on the frame 104. The frame 104 may also support the drive train 100. The set of ground engaging members may be configured to provide mobility to the machine 102. In the embodiment of FIG. 1, the set of ground engaging members are wheels. Further, the set of ground engaging members may include a pair of front ground engaging members 106, 108 disposed proximate to a front side of the machine 102. The set of ground engaging members 106 may also include a pair of rear ground engaging members 110, 112 disposed proximate to a rear side of the machine 102. Alternatively or additionally, the set of ground engaging members may include tracks (not illustrated). Although figures illustrate, the pair of front ground engaging members 106, 108 and the pair of rear ground engaging members 110, 112, it may be recognized that the machine 102 may include any number of ground engaging members.

The machine 102 includes a power source 114 configured to generate driving power for various components including, but not limited to, the front and/or the rear set of ground engaging members 106, 108 and 110, 112. The power source 114 may be an internal combustion engine. For example, the power source 114 may be embodied in the form of a diesel engine, a gasoline engine, a gaseous fuel-powered engine, or any other engine known in the art. It is also contemplated that the power source 114 may alternatively include a non-combustion source such as, for example, an electric motor, or be embodied in any other known non-combustion source of power.

The drive train 100 is configured to selectively transmit the driving power generated by the power source 114 to at least one of the pair of front ground engaging members 106, 108 and the pair of rear ground engaging members 110, 112. In the illustrated embodiment of FIG. 1, the drive train 100 is configured to transmit the driving power only to the pair of rear ground engaging members 110, 112.

The drive train 100 includes an input shaft 116 defining an axis A-A′. The input shaft 116 may be configured to receive the driving power from the power source 114 via a transmission system 118. The transmission system 118, also alternatively referred to as a gear box, may be operatively coupled between the power source 114 and a first end 120 of the input shaft 116. The transmission system 118 may include various components such as, for example, gears, pinions, and the like to transmit the driving power from the power source 114 to the input shaft 116 at various speed-to-torque ratios. The input shaft 116 may rotate about the axis A-A′ upon receiving the driving power through the transmission system 118. In various examples, the transmission system 118 may include a power-shift transmission, a continuously variable transmission, a hybrid transmission, or any other types of transmission systems known in the art.

The drive train 100 further includes a pair of axle shafts that are associated with the pair of rear ground engaging members 110, 112. As shown in FIG. 1, a first axle shaft 122 and a second axle shaft 124 may be coupled to the rear ground engaging members 110, 112 respectively. Each of the first axle shaft 122 and the second axle shaft 124 may include first ends 126, 128 and second ends 130, 132 respectively. The first ends 126, 128 of the first axle shaft 122 and the second axle shaft 124 may be coupled to the rear ground engaging members 110, 112 respectively, for rotation therewith.

The drive train 100 also includes a differential assembly 200 disposed adjacent to a second end 119 of the input shaft 116. In general, the differential assembly 200 may be configured to receive driving power from the input shaft 116 and provide a rotational output to the pair of the first axle shaft 122 and the second axle shaft 124 associated with the pair of rear ground engaging members 110, 112. The differential assembly 200 may allow the pair of rear ground engaging members 110, 112 to rotate at different speeds and different torques relative to one another when required. As shown, the differential assembly 200 may be disposed in the proximity of the first ends 126, 128 of the first axle shaft 122 and the second axle shaft 124, respectively.

The differential assembly 200 will be explained hereinafter in conjunction with the drive train 100 of FIG. 1. However, it may be noted that the differential assembly 200 disclosed herein may be configured for implementation in powertrains of various other configurations known in the art. For example, the differential assembly 200 may be configured to transmit the driving power to the pair of front ground engaging members 106, 108, the pair of rear ground engaging members 110, 112, a combination thereof, or as desired.

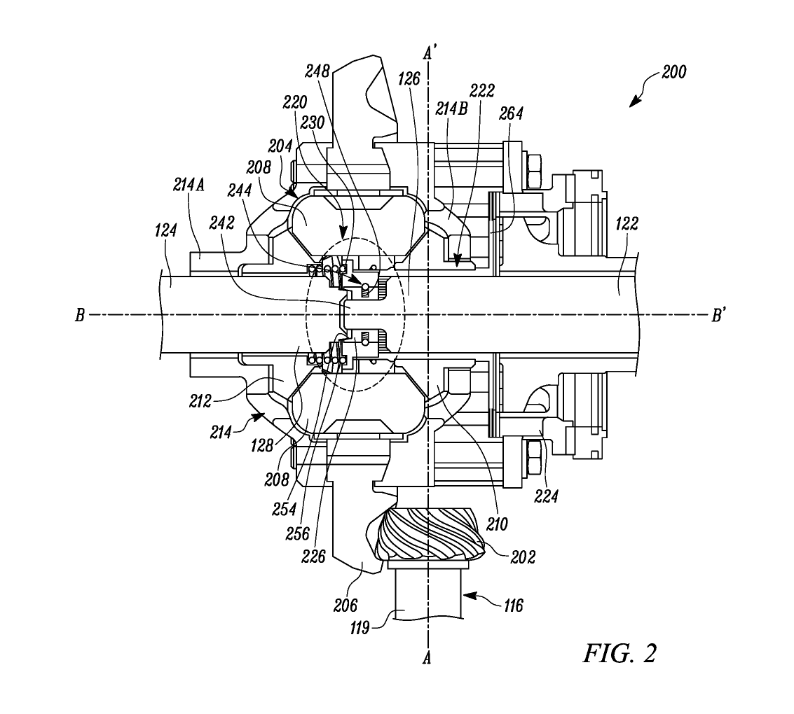

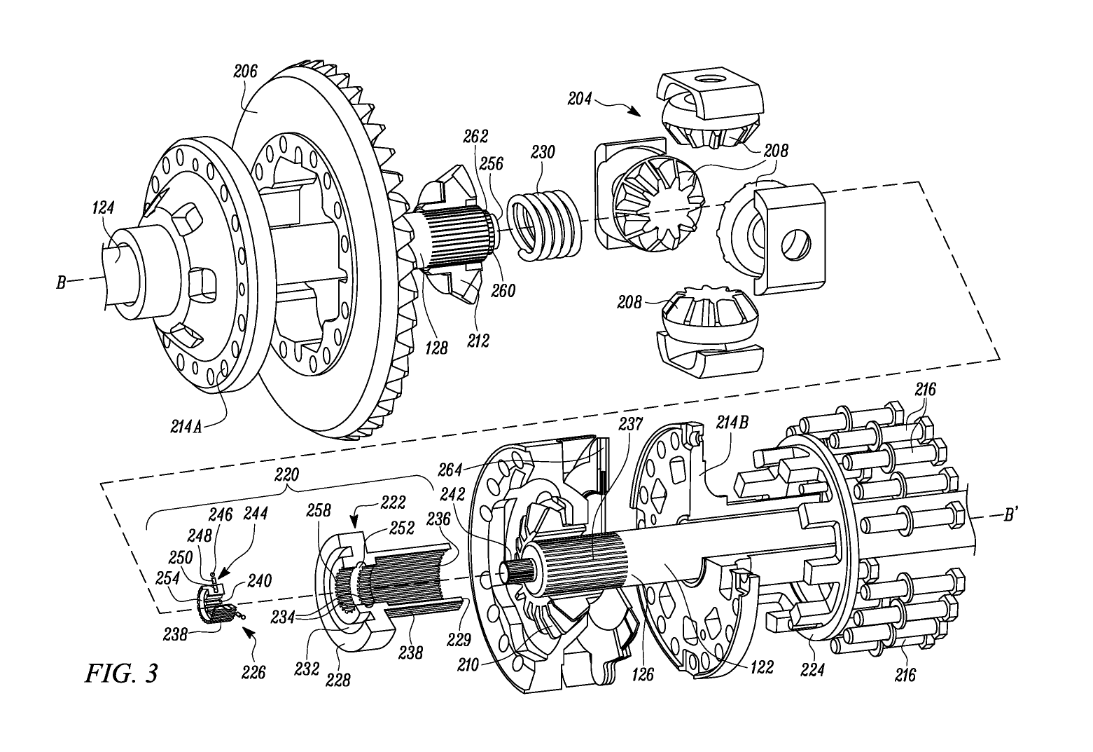

FIG. 2 depicts side sectional view a differential assembly 200 and FIG. 3 depicts a perspective exploded view of the differential assembly 200. Referring to FIG. 2 and FIG. 3 simultaneously, the differential assembly 200 includes a drive gear 202 for receiving a rotational input from the input shaft 116. The drive gear 202 may be fixedly coupled to the input shaft 116 at the second end 119 thereof. Further, the input shaft 116, as disclosed earlier herein, may receive the driving power from the power source 114 through the transmission system 118. In the illustrated embodiment of FIG. 2, the drive gear 202 is a bevel gear.

The differential assembly 200 also includes a differential gear set 204. In the illustrated embodiment, the differential gear set 204 includes a driven gear 206, and differential gears 208 carried by the driven gear 206. The driven gear 206 is configured to engage with the drive gear 202 so as to rotate in unison with the drive gear 202 during operation of the differential assembly 200. In the illustrated embodiment, the driven gear 206 is embodied in the form of a ring gear. The driven gear 206 has an axis of rotation B-B′ about its center. The driven gear 206 may be disposed in mesh with the drive gear 202 such that the axis A-A″ of the input shaft 116 and the axis of rotation B-B′ of the driven gear 206 are disposed perpendicularly to each other. Further, the drive gear 202 may transmit the rotatory power to the driven gear 206 causing the driven gear 206 to rotate about the axis of rotation B-B′.

With continued reference to FIGS. 2 and 3, the differential assembly 200 may also include a first pinion gear 210, a second pinion gear 212, and a cover member 214. The cover member 214 (also alternatively referred to as ‘differential case 214’ or ‘differential housing 214’) is rigidly coupled to the driven gear 206, and houses the first pinion gear 210 and the second pinion gear 212. In the illustrated embodiment of FIG. 3, the differential assembly 200 includes two cover members namely, a first cover member 214A and a second cover member 214B. However, in other embodiments, the differential assembly 200 may include a single-piece cover member or a cover member that is formed from more than two pieces. The specific number of pieces that form the cover member 214 of the present disclosure is merely exemplary in nature and hence, non-limiting of this disclosure. Persons ordinarily skilled in the art will appreciate that the cover member 214 disclosed herein may be made from any number of pieces without deviating from the spirit of the present disclosure.

The first cover member 214A may be disposed adjacent to a first side of the driven gear 206. Further, the first cover member 214A may be configured to at least partially enclose the first side of the driven gear 206. The second cover member 214B may be disposed adjacent to a second side of the driven gear 206. Further, the second cover member 214B may be configured to at least partially enclose the second side of the driven gear 206.

The first and second cover members 214A, 214B are rigidly coupled to the driven gear 206. In the illustrated embodiment, each of the first and second cover members 214A, 214B may be coupled to the driven gear 206 with the help of fasteners 216 (shown in FIG. 3). In an example as shown in FIG. 3, the fasteners 216 are embodied in the form of bolts. However, it may be contemplated to use other structures and methods known in the art for coupling each of the first and second cover members 214A, 214B to the driven gear 206.

In an embodiment, the differential assembly 200 may operate so that a substantially equal amount of torque may be transmitted to each the first axle shaft 122 and the second axle shaft 124. As such, the first axle shaft 122 and the second axle shaft 124 can rotate at different speeds relative to each other.

Each of the first pinion gear 210 and the second pinion gear 212 is housed within the cover member 214 and are configured to receive a rotational input from the driven gear 206. The first pinion gear 210 may be disposed on a first side of the driven gear 206 and the second pinion gear 212 may be disposed on a second side, opposite to the first side, of the driven gear 206. Moreover, the first pinion gear 210 and the second pinion gear 212 may be in a meshing engagement with each of the differential gears 208.

Further, the first pinion gear 210 is coupled with the first axle shaft 122, and the second pinion gear 212 is coupled with the second axle shaft 124. As such, the first pinion gear 210 is coupled with the first axle shaft 122, and the second pinion gear 212 is coupled with the second axle shaft 124 adjacent to the first ends 126, 128 of the respective axle shaft. The first pinion gear 210 and the second pinion gear 212 rotate with the corresponding axle shaft.

The differential assembly 200 further includes a differential locking arrangement 220, positioned within the cover member 214. The differential locking arrangement 220 is associated with at least one of the first axle shaft 122 and the second axle shaft 124. In an embodiment illustrated in FIGS. 2 and 3, the differential locking arrangement 220 is mounted on the first axle shaft 122. The differential locking arrangement 220 is adapted to selectively lock the first axle shaft 122 with the second axle shaft 124.

The differential locking arrangement 220 includes a first locking member 222, a lock actuator 224 and a sleeve member 226. The first locking member 222 is engaged with the first axle shaft 122 and the first pinion gear 210, while the lock actuator 224 is operably connected to the first locking member 222. The lock actuator 224 may be adapted to engage the first locking member 222 with the second axle shaft 124 in order to lock the first axle shaft 122 with the second axle shaft 124. It may herein be noted that in alternative embodiments, the first locking member 222 may be engaged with the second axle shaft 124 and the second pinion gear 212, and in such an arrangement the lock actuator 224 may be adapted to engage the first locking member 222 with the first axle shaft 122 to lock the first axle shaft 122 with the second axle shaft 124. When locked, the first axle shaft 122 and the second axle shaft 124 rotate at a same speed and therefore an equal amount of torque is transmitted to each of the pair of rear ground engaging members 110, 112.

Specifically, as best illustrated in FIG. 3, the first locking member 222 has a hollow cylindrical profile having a first end portion 228, a second end portion 229 opposite to the first end portion 228 and a set of splines formed on inner and outer surface of the first locking member 222. The first end portion 228 of the first locking member 222 is associated with at least one return spring member, such as a return spring member 230, positioned within the differential case 214. In an embodiment of the present disclosure, the first end portion 228 of the first locking member 222 includes a circumferential tubular groove 232 to accommodate an end portion of the return spring member 230.

An opposite end of the return spring member 230 may be engaged with at least one of the second axle shaft 124 and the second pinion gear 212. Owing to such placement, the return spring member 230 may apply a force on the first locking member 222. The return spring member 230 may be a coiled helical spring. The force applied by the return spring member 230 on the first locking member 222 is directionally opposite to the force applied by the lock actuator 224 on the first locking member 222. Therefore, the force applied by the return spring member 230 on the first locking member 222 may assist in disengagement of the first locking member 222 from the second axle shaft 124, when the force applied by the lock actuator 224 is removed.

The set of splines formed on the first locking member 222 include a first inner splined surface 234, a second inner splined surface 236, and an outer splined surface 238. Each of the set of splines includes a set of elongated grooves. The first inner splined surface 234 of the set of splines is slidably engaged with the sleeve member 226. The sleeve member 226 (also referred to as “sliding sleeve 226”) also includes an inner splined surface 240 slidably engaged with splines on an extension 242 on the first end 126 of the first axle shaft 122. Owing to such engagement, the sleeve member 226 is adapted to slide along the axis B-B′ on the first axle shaft 122. In order to selectively restrict such sliding movement of the sleeve member 226, with respect to the first locking member 222, a resilient mechanism 244 is located between the sleeve member 226 and the first locking member 222.

The resilient mechanism 244 includes a set of balls, such as, a ball 246 and a set of spring members, such as, a spring member 248. Each of the set of balls and spring members is positioned within a set of radial slots, such as, a radial slot 250 on the sleeve member 226. In each of the radial slots, a spring member, such as, the spring member 248 is positioned and a ball, such as, the ball 246 is provided on top of the spring member 248. The ball 246 is also engaged with a slot 252 on the first locking member 222. The spring member 248 applies a pushing force on the ball 246 in contact with the slot 252 on the first locking member 222, thereby engaging the sleeve member 226 with the first locking member 222. Therefore, when a force along the axis B-B′ (a pushing force) is applied on the first locking member 222, the first locking member 222 moves along with the sleeve member 226. However, when a force applied on the first locking member 222 (along the axis B-B′) is greater than the force of the spring members, the set of balls get pushed and as a result, the sleeve member 226 gets disengaged from the first locking member 222. In such a situation, the first locking member 222 may move relative to the sleeve member 226 along the first inner splined surface 234 on the first end portion 228 of the first locking member 222. In an example of the present disclosure, the spring members may be coiled helical springs, and the balls may be metallic spheres.

The sleeve member 226 further includes a friction surface. The friction surface of the sleeve member 226 is adapted to frictionally engage with a friction surface of the second axle shaft 124. In accordance with one embodiment of the present disclosure, the friction surface of the sleeve member 226 is embodied as a first conical surface 254, and the friction surface of the second axle shaft 124 is embodied as a second conical surface 256. As illustrated, the second conical surface 256 is disposed at the first end 128 of the second axle shaft 124. An engagement of the first conical surface 254 with the second conical surface 256 frictionally connects the second axle shaft 124 with the sleeve member 226, and thus with the first locking member 222. Frictional engagement of the second axle shaft 124 with the first axle shaft 122 enables synchronization of rotational speeds of the first axle shaft 122 and the second axle shaft 124.

In various examples, one or more of the first conical surface 254 and the second conical surface 256 may be provided with a friction lining made of a suitable and durable material, to increase friction coefficient of the first conical surface 254 and the second conical surface 256. In various other examples, the first conical surface 254 may have any other shape and profile, e.g., a vertically flat profile and the second conical surface 256 may have a complimentary shape and profile, e.g., a vertically flat profile.

As shown in FIG. 3, a first set of engaging members 258 are disposed on the first locking member 222. The first set of engaging members 258 are adapted to engage with the second axle shaft 124. Specifically, the first set of engaging members 258 are adapted to engage with a second set of engaging members 260 of the second axle shaft 124. In an embodiment, the first inner splined surface 234, connecting the first locking member 222 with the sleeve member 226, also aids in connecting the first locking member 222 with the second axle shaft 124. Specifically, an end portion of the first inner splined surface 234, defines the first set of engaging members 258 adapted to engage with a set of outwardly projecting tabs 262 located on the first end 128 of the second axle shaft 124. As illustrated, a number of tabs on the set of outwardly projecting tabs 262 correspond to number of elongated grooves defining the first inner splined surface 234. Further, each tab of the set of outwardly projecting tabs 262 may be shaped to engage with the first inner splined surface 234. When the first set of engaging member 258 of the first locking member 222 are attached with the second set of engaging members 260, relative rotation of the first axle shaft 122 with respect to the second axle shaft 124 is restricted, and thus the first axle shaft 122 is locked with the second axle shaft 124.

The second inner splined surface 236 of the first locking member 222 is slidably engaged with splined surface 237 at the first end 126 of the first axle shaft 122. The outer splined surface 238 of the first locking member 222 is engaged with a splined surface (not illustrated) on the first pinion gear 210. In alternative embodiments of the present disclosure, the first locking member 222 may be coupled with the first end 126 of the first axle shaft 122 and the first pinion gear 210, using any other means such that the first locking member 222 remains movable along the axis B-B′, with respect to the first axle shaft 122 and the first pinion gear 210. The second end portion 229 of the first locking member 222 extends out of the differential case. A flange portion 264 is disposed at the second end portion 229 of the first locking member 222.

The lock actuator 224 is carried by the differential case 214, and is connected to the first locking member 222. Specifically, the lock actuator 224 is connected to the flange portion 264 of the first locking member 222. During operation of the differential assembly 200, the lock actuator 224 can rotate independent of the first locking member 222. The lock actuator 224, when actuated, is adapted to apply pushing force on the first locking member 222 in order to move the first locking member 222 along the axis B-B.′ In various examples, the lock actuator 224 may be powered by a pneumatic actuating system, a hydraulic actuating system, mechanical, electromechanical, or magnetic actuating system.

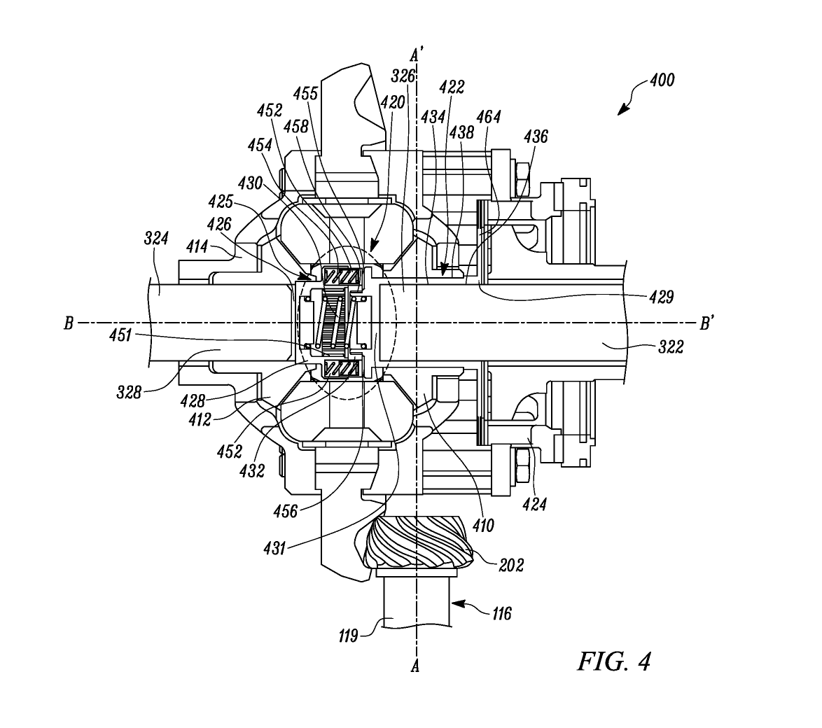

Referring to FIG. 4, a differential assembly 400 in accordance with another embodiment of this disclosure is illustrated. Since the differential assembly 400 is generally reminiscent of the differential assembly 200 from FIG. 2 and FIG. 3, components which are similar between the differential assembly 400 and the differential assembly 200 will be annotated by similar numbers increased by 200. Moreover, it should be noted that for purposes of brevity, re-capitulation in the explanation pertaining to components similar between the differential assembly 200 and the differential assembly 400 has been avoided herein.

In the illustrated embodiment of FIG. 4, the differential assembly 400 includes a differential locking arrangement 420 positioned within a cover member 414. The differential locking arrangement 420 is associated with each of a first axle shaft 322 and a second axle shaft 324. The differential locking arrangement 420 includes a first locking member 422, and a second locking member 425. The first locking member 422 is engaged with the first axle shaft 322 and a first pinion gear 410. The second locking member 425 is engaged with at least one of the second axle shaft 324 and a second pinion gear 412. Particularly, a first end 328 of the second axle shaft 324 may be connected to the second pinion gear 412 and the second pinion gear 412 may be connected to the second locking member 425. The differential locking arrangement 420 is adapted to selectively engage the first locking member 422 with the second locking member 425 to lock the first axle shaft 322 with the second axle shaft 324.

The second locking member 425 includes an end plate 426 facing the second axle shaft 324, and a cylindrical peripheral member 428 extending from the end plate 426. Further, the first locking member 422 has a cylindrical profile having an intermediate plate 431, a first cylindrical member 432, and a second cylindrical member 434. Each of the first cylindrical member 432 and the second cylindrical member 434 extend from, and in opposite directions of, the intermediate plate 431. Further, the first cylindrical member 432 faces the cylindrical peripheral member 428 to define a hollow cavity therebetween. A return spring member 430 is positioned within the first cylindrical member 432 and the cylindrical peripheral member 428. Owing to such placement, the return spring member 430 applies a force on the first locking member 422, and an opposite force on the second locking member 425.

The second cylindrical member 434 of the first locking member 422 includes an inner splined surface 436 slidably engaged with the splined surface (not numbered) at a first end 326 of the first axle shaft 322. An outer splined surface 438 on the second cylindrical member 434 of the first locking member 422 is engaged with splined surface (not numbered) on the first pinion gear 410. In alternative embodiments of the present disclosure, the first lock member 422 may be coupled with the first end 326 of the first axle shaft 322, and the first pinion gear 410 using any other means such that the first locking member 422 remains movable along the axis B-B′, with respect to the first axle shaft 322, and the first pinion gear 410. A flange portion 464 is disposed at a second end portion 429 of the first locking member 422.

A lock actuator 424, such as the lock actuator 224, is carried by the differential case 414, and is connected to the first locking member 422. Specifically, the lock actuator 424 is connected to the flange portion 464 of the first locking member 422. The lock actuator 424, when actuated, is adapted to apply pushing force on the first locking member 422 in order to force the first locking member 422 along the axis B-B.′ In various examples, the lock actuator 424 may be a powered by a pneumatic actuating system, a hydraulic actuating system, mechanical, electromechanical, or magnetic actuating system.

The cylindrical peripheral member 428 of the second locking member 425 includes at least one channel 452 adapted to hold at least one synchronizing spring 454 connected to a friction surface 455. The friction surface 455 faces a second friction surface 456 on the first cylindrical member 432 of the first locking member 422. The friction surface 455 of the second locking member 425 is adapted to frictionally engage with the second friction surface 456 on the first cylindrical member 432 of the first locking member 422. An engagement of the friction surface 455 with the second friction surface 456 frictionally connects the second axle shaft 324 with the first axle shaft 322. Accordingly, frictional engagement of the second axle shaft 324 with the first axle shaft 322 enables synchronization of rotational speeds of the first axle shaft 322 and the second axle shaft 324.

The first cylindrical member 432 of the first locking member 422 includes a first set of engaging members 458. The first set of engaging members 458 in an embodiment of the present disclosure may be a set of splines. Further, the cylindrical peripheral member 428 of the second locking member 425 includes a second set of engaging members 451. The first set of engaging members 458 of the first locking member 422 are adapted to engage with the second set of engaging members 451 of the second locking member 425 to lock the first axle shaft 322 with the second axle shaft 324.

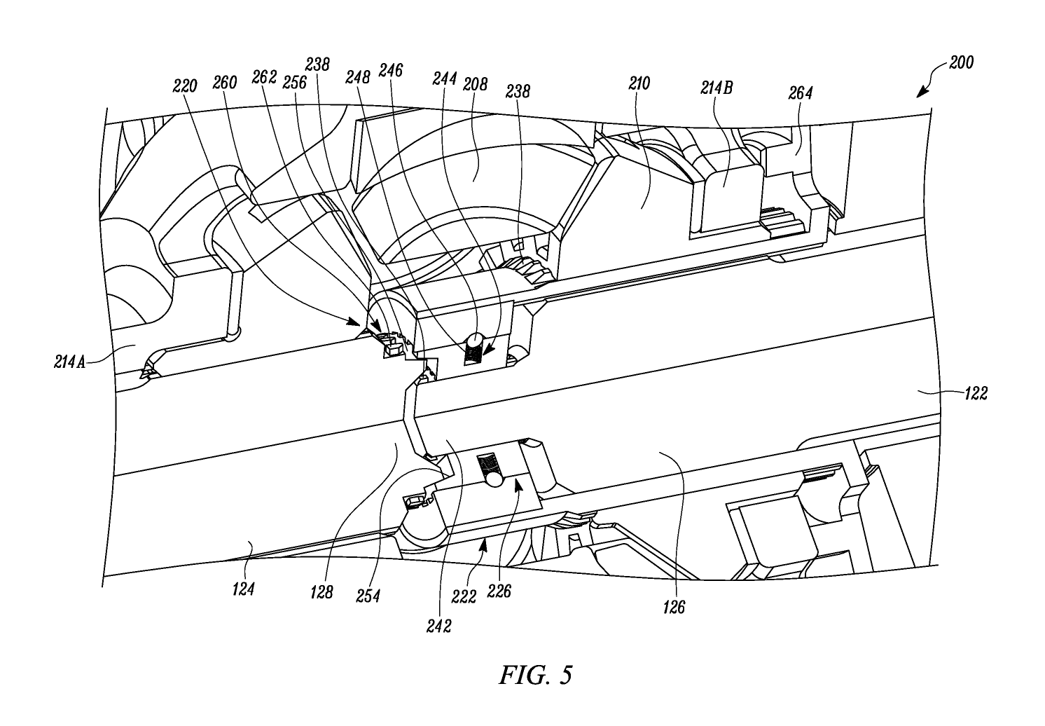

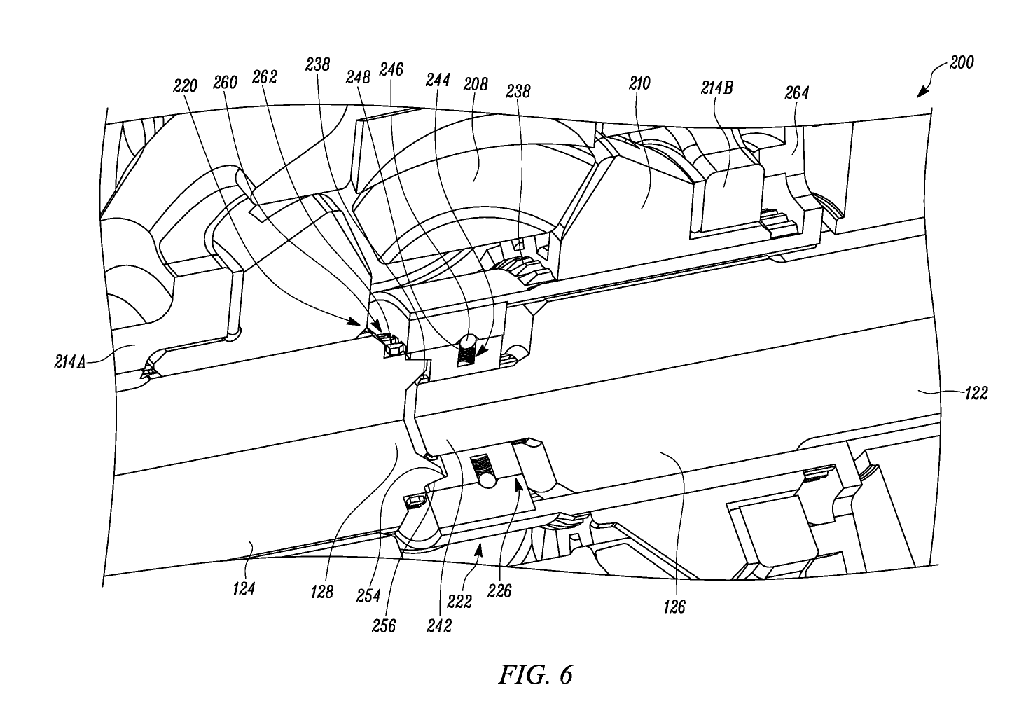

Referring now to FIGS. 5, 6, and 7, showing the differential locking arrangement 220 of the differential assembly 200 in three different positions. FIG. 5 illustrates the differential locking arrangement 220 in a first position wherein the first axle shaft 122 is disengaged from the second axle shaft 124. In the first position, there is no force applied by the lock actuator 224, and owing to the return spring member 230 (shown in FIGS. 2, and 3), the first axle shaft 122 is disengaged from the second axle shaft 124. In such a position of the differential locking arrangement 220, the first axle shaft 122 and the second axle shaft 124 may rotate at differential speeds, as the differential assembly 200 is unlocked. FIG. 6 illustrates the differential locking arrangement 220 in a second position wherein the first axle shaft 122 is frictionally engaged with the second axle shaft 124.

In the second position, force is applied by the lock actuator 224, as a result the first locking member 222 slidably moves along the axis B-B′, with respect to the first axle shaft 122. The sleeve member 226 remaining connected with the first locking member 222 may also move along the axis B-B′, with respect to the first axle shaft 122. Further, the friction surface of the sleeve member 226, such as the first conical surface 254 may come in contact with the second conical surface 256 at the first end 128 of the second axle shaft 124, and accordingly the first axle shaft 122 is frictionally engaged with the second axle shaft 124. The frictional engagement of the first axle shaft 122 with the second axle shaft 124 enables the synchronization of rotational speeds of the first axle shaft 122 and the second axle shaft 124.

As per another embodiment of the present disclosure illustrated in FIG. 4, when the force is applied by the lock actuator 424, the first locking member 422 slidably moves along the axis B-B′ with respect to the first axle shaft 322. Further, the friction surface 455 of the second locking member 425 gets frictionally engage with the second friction surface 456 on the first cylindrical member 432 of the first locking member 422. Further the force applied by the lock actuator 424, presses the friction surface 455 towards the second friction surface 456, pressing the synchronizing spring 454. Such frictional engagement of the friction surface 455 of the second locking member 425 with the second friction surface 456 of the first locking member 422 frictionally connects the second axle shaft 324 with the first axle shaft 322. Accordingly, frictional engagement of the second axle shaft 324 with the first axle shaft 322 enables synchronization of rotational speeds of the first axle shaft 322 and the second axle shaft 324.

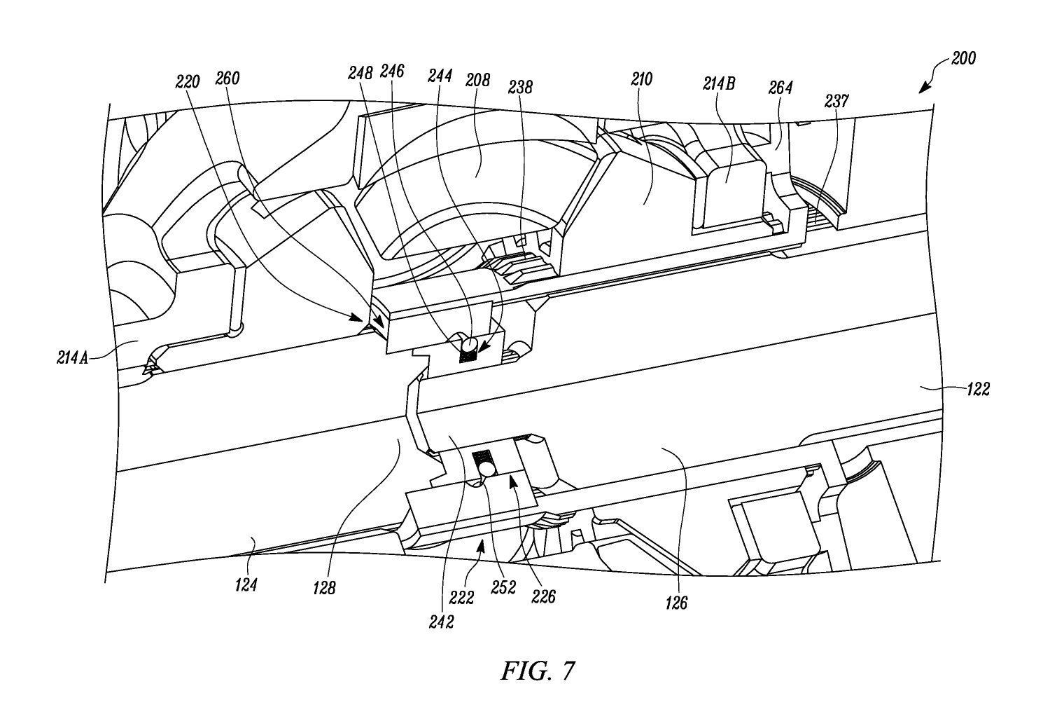

FIG. 7 illustrates the differential locking arrangement 220 in a third position wherein the first axle shaft 122 is locked with the second axle shaft 124. In the third position, force is applied by the lock actuator 224, as a result the first locking member 222 slidably moves further, along the axis B-B′, with respect to the first axle shaft 122. The sleeve member 226 is displaced with respect to the first locking member 222, as the force applied by the lock actuator 224 overcomes the force applied by the resilient mechanism 244 engaging the sleeve member 226. Further, the first set of engaging members 258 of the first locking member 222 lock with the second set of engaging members 260 of the second axle shaft 124, and accordingly the first axle shaft 122 is locked with the second axle shaft 124. In such a position of the differential locking arrangement 220, the first axle shaft 122 and the second axle shaft 124 may rotate at a same speed, as the differential assembly 200 is locked.

As per another embodiment of the present disclosure illustrated in FIG. 4, when the further force is applied by the lock actuator 424, the first locking member 422 slidably moves further along the axis B-B′ with respect to the first axle shaft 322. Because of the force applied by the lock actuator 424, the return spring member 430 gets compressed, and the first set of engaging members 458 get locked with the second set of engaging members 451 and accordingly the first axle shaft 322 is locked with the second axle shaft 324. In such a position of the differential locking arrangement 420, the first axle shaft 322 and the second axle shaft 324 may rotate at a same speed, as the differential assembly 400 is locked.

Various additional components and features associated with the differential assembly 200/400 such as, seals, rings, bushings, spacers, bearings and the like have been omitted in the illustrations and explanation for the sake of simplicity and aiding clarity in understanding of the present disclosure. Therefore, such omission of the additional components and/or features must not be construed as being limiting of this present disclosure, rather the differential assembly 200/400 may be implemented with such additional components and/or features depending on specific requirements of an application.

### INDUSTRIAL APPLICABILITY

The present disclosure relates to a differential assembly for a machine. More specifically, the present disclosure relates to a lockable differential assembly for a machine.

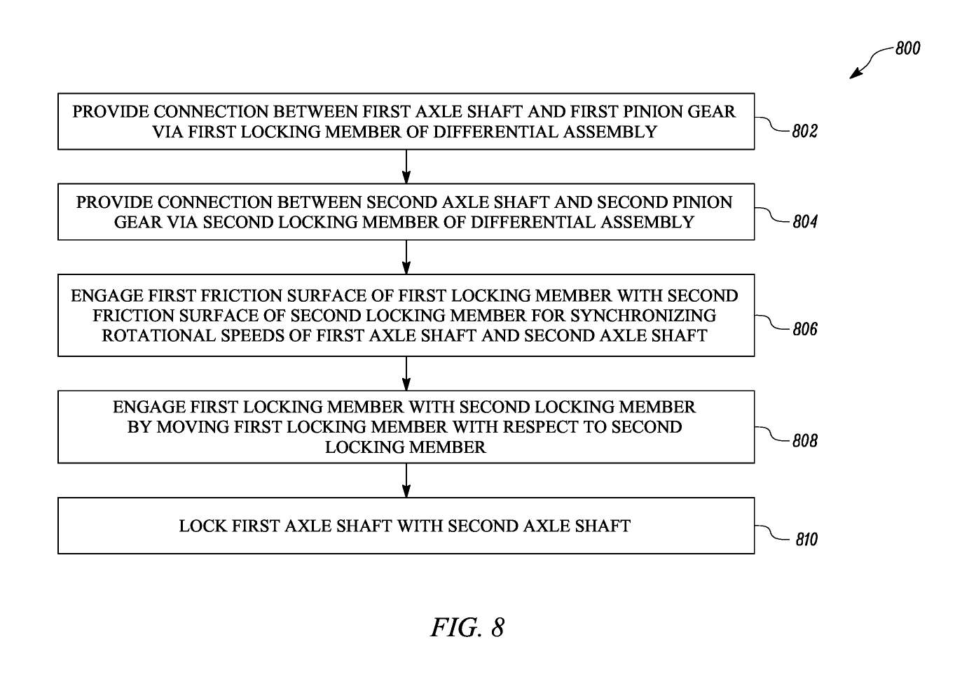

FIG. 8 is a flowchart for a method 800 of transmitting driving power by a differential assembly, such as the differential assembly 200 or the differential assembly 400, according to various embodiments of the present disclosure. For purposes of the present disclosure, embodiments disclosed in conjunction with FIGS. 1 to 7 may be considered as being pursuant to the method 800. Therefore, for the sake of brevity, the aspects of the present disclosure which are already explained in detail in the description of FIG. 1, through FIG. 7 are not explained in detail with regard to the description of the method 800.

At step 802, the method includes providing a connection between a first axle shaft, such as the first axle shaft 122 or the first axle shaft 322, and a first pinion gear, such as the first pinion gear 210 or the first pinion gear 410. The connection between the first axle shaft and the first pinion gear may be provided via a first locking member, such as the first locking member 222 or the first locking member 422. At step 804, the method includes providing a connection between a second axle shaft, such as the second axle shaft 124 or the second axle shaft 324, and a second pinion gear, such as the second pinion gear 212 or the second pinion gear 412. The connection between the second axle shaft and the second pinion gear may be made by splines. The second pinion gear may be connected to a second locking member, such as the second locking member 425.

At step 806, the method includes engaging a friction surface 455 of the first locking member 422 with a second friction surface 456 of the second locking member 425 for synchronizing rotational speeds of the first axle shaft 322 and the second axle shaft 324. In order to engage the friction surface 455 of the first locking member 422 with the second friction surface 456 of the second locking member 425, a force is applied on the first locking member 422, by a lock actuator, such as the lock actuator 424, to move the first locking member 422 towards the second locking member 425. Meanwhile, an opposing force is applied on the first locking member 422 and the second locking member 425, by a return spring member 430, to disengage the first locking member 422 from the second locking member 425 once the force applied by the lock actuator 424 is removed.

At step 808, the method includes engaging the first locking member 422 with the second locking member 425 by moving the first locking member 422 with respect to the second locking member 425. Further, at step 810, the method includes locking the first axle shaft 322 with the second axle shaft 324 when the first locking member 422 is engaged with the second locking member 425.

Embodiments of the present disclosure have applicability for implementation and use in reducing an overall weight and size of a differential assembly. Accordingly, embodiments of the present disclosure can help reduce an overall weight and size of a differential casing that is used to enclose components of a differential assembly therein. Previously known differential assemblies were conventionally produced using complex, bulky, and/or expensive components, for example a plurality of locking friction discs present on the differential case 214, and one or more springs on the differential case 214. However, with use of the differential locking assembly 220/420 (shown in FIGS. 2 and 4 respectively) disclosed herein, a need of having plurality of locking frictions discs and one or more springs on the differential case 214 on the differential case 214 has been precluded, and accordingly the complexity and cost associated with the differential assembly has been reduced.

Moreover, the differential assemblies 200/400 of the present disclosure also allow for complete, slip proof, locking of the first axle shaft 122 with the second axle shaft 124, when the first set of engaging members 258 of the first locking member 222 lock with the second set of engaging members 260 of the second axle shaft 124. Further, the friction surface of the sleeve member 226, such as the first conical surface 254 comes in contact with the second conical surface 256 at the first end 128 of the second axle shaft 124, prior to engagement of the first locking member 222 with the second set of engaging members 260. Because of such engagement of the friction surfaces, synchronization of the speed of the first axle shaft 122 with the second axle shaft 124 occurs.

Furthermore, as the components used in the differential assemblies 200/400 are simple and light-weight, such components may help manufacturers offset time and costs previously incurred with the use of complex, bulky, and/or expensive components when nesting differential gears inside a given differential assembly. Therefore, an overall size, weight, and production cost for the differential assemblies 200/400 of the present disclosure is minimized. Additionally, elimination of components such as springs, set of locking discs from outside the differential case, may provide space for fitment of other components of the drive train 100.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A differential assembly for a drive train having a first axle shaft and a second axle shaft, the differential assembly comprising:
a differential gear set;
a first pinion gear disposed on the first axle shaft;
a second pinion gear disposed on the second axle shaft, each of the first pinion gear and the second pinion gear being in meshing engagement with the differential gear set; and
a differential locking arrangement mounted on at least one of the first axle shaft and the second axle shaft, wherein the differential locking arrangement is adapted to selectively lock the first axle shaft with the second axle shaft.

2. The differential assembly of claim 1, wherein the differential locking arrangement comprises:
a first locking member movably engaged with each of the first axle shaft and the first pinion gear; and
a lock actuator connected with the first locking member, wherein the lock actuator is adapted to engage the first locking member with the second axle shaft, to lock the first axle shaft with the second axle shaft.

3. The differential assembly of claim 2 further comprising:
a differential case; and
at least one return spring member, disposed within the differential case, adapted to apply a resilient force on the first locking member in a first direction.

4. The differential assembly of claim 2, wherein the first locking member comprises a first set of engaging members adapted to engage with a second set of engaging members of the second axle shaft.

5. The differential assembly of claim 4, wherein the first set of engaging members comprises a set of splines formed on an inner surface of the first locking member.

6. The differential assembly of claim 4, wherein the second set of engaging members comprises a set of outwardly projecting tabs located on an end portion of the second axle shaft.

7. The differential assembly of claim 2, further comprising:
a sleeve member slidably engaged with each of the first locking member and the first axle shaft; and
a resilient mechanism located between the sleeve member and the first locking member, wherein the resilient mechanism is adapted to selectively restrict sliding movement of the sleeve member with respect to the first locking member.

8. The differential assembly of claim 7, wherein the sleeve member comprises a first conical surface to frictionally connect with a second conical surface of the second axle shaft, and to synchronize rotational speeds of the first axle shaft and the second axle shaft.

9. The differential assembly of claim 2, wherein the differential locking arrangement further comprising a second locking member engaged with each of the second axle shaft and the second pinion gear such that the lock actuator is adapted to engage the first locking member with the second locking member, to lock the first axle shaft with the second axle shaft.

10. The differential assembly of claim 2, wherein the first locking member comprises a first friction surface and the second locking member comprises a second friction surface, the first friction surface of the first locking member adapted to frictionally connect with the second friction surface of the second locking member, and to synchronize rotational speed of the first axle shaft and the second axle shaft.

11. A drive train for transmitting driving power from a power source to a first axle shaft and a second axle shaft, the drive train comprising:
an input shaft configured to receive the driving power from the power source;
a drive gear drivably coupled to the input shaft; and
a differential assembly for transmitting the driving power from the drive gear to the first axle shaft and the second axle shaft, the differential assembly comprising:
a differential gear set connected to the drive gear;
a first pinion gear disposed on the first axle shaft;
a second pinion gear disposed on the second axle shaft, each of the first pinion gear and the second pinion gear being in meshing engagement with the differential gear set; and
a differential locking arrangement mounted on at least one of the first axle shaft and the second axle shaft, wherein the differential locking arrangement is adapted to selectively lock the first axle shaft with the second axle shaft.

12. The drive train of claim 11, wherein the differential locking arrangement comprises:
a first locking member movably engaged with each of the first axle shaft and the first pinion gear; and
a lock actuator connected with the first locking member, wherein the lock actuator is adapted to engage the first locking member with the second axle shaft, to lock the first axle shaft with the second axle shaft.

13. The drive train of claim 12 further comprising:
a differential case; and
at least one return spring member, disposed within the differential case, adapted to apply a resilient force on the first locking member in a first direction.

14. The drive train of claim 12, wherein the first locking member comprises a first set of engaging members adapted to engage with a second set of engaging members of the second axle shaft.

15. The drive train of claim 14, wherein the first set of engaging members comprises a set of splines formed on an inner surface of the first locking member, and the second set of engaging members comprises a set of outwardly projecting tabs located on an end portion of the second axle shaft.

16. The drive train of claim 12, further comprising:
a sleeve member slidably engaged with each of the first locking member and the first axle shaft; and
a resilient mechanism located between the sleeve member and the first locking member, wherein the resilient mechanism is adapted to selectively restrict sliding movement of the sleeve member with respect to the first locking member.

17. The drive train of claim 16, wherein the sleeve member comprises a first conical surface adapted to frictionally connect with a second conical friction surface of the second axle shaft, and to synchronize rotational speeds of the first axle shaft and the second axle shaft.

18. The drive train of claim 12, wherein the first locking member comprises a first friction surface, and the second locking member comprises a second friction surface, the first friction surface of the first locking member adapted to frictionally connect with the second friction surface of the second locking member, and to synchronize rotational speed of the first axle shaft and the second axle shaft.

19. A method of transmitting driving power by a differential assembly, the method comprising:
providing a connection between a first axle shaft and a first pinion gear via a first locking member of the differential assembly;
providing a connection between a second axle shaft and a second pinion gear, wherein a second locking member of the differential assembly is connected to the second pinion gear;
engaging a first friction surface of the first locking member with a second friction surface of the second locking member for synchronizing rotational speeds of the first axle shaft and the second axle shaft;
engaging the first locking member with the second locking member by moving the first locking member with respect to the second locking member; and
locking the first axle shaft with the second axle shaft.

20. The method of claim 19, further comprising,
applying a force on the first locking member, by a lock actuator, to move the first locking member towards the second locking member; and
applying an opposing force on the first locking member and the second locking member, by a return spring member, to disengage the first locking member from the second locking member.
